(19) United States
(12) Patent Application Publication
(10) Pub. No.: US 2026/0186775 A1
(43) Pub. Date: Jul. 2, 2026

(54) SYSTEMS AND METHODS FOR MONITORING GOVERNANCE

(71) Applicant: The PNC Financial Services Group, Inc., Pittsburgh, PA (US)

(72) Inventor: Brian WARGO, Washington, PA (US)

(73) Assignee: The PNC Financial Services Group, Inc., Pittsburgh, PA (US)

(21) Appl. No.: 19/285,077

(22) Filed: Jul. 30, 2025

Related U.S. Application Data
(60) Provisional application No. 63/739,255, filed on Dec. 27, 2024.

(51) Int. Cl. G06F 8/77

(52) U.S. Cl. CPC G06F 8/77

(57) ABSTRACT

A computer implemented method for providing generating an interactive graphical user interface for providing performance status information for one or more containers, the one or more containers containing governable artifacts configured to be monitored for adherence to governance standards; receiving a response from the one or more containers, the response including a result of a governance compliance check indicating adherence to the governance standards; and displaying on the interactive graphical user interface an indicator representative of the result of the governance compliance check, based on the response from the containers, on a graphical interface including a plurality of computer display boxes configured to indicate a status of adherence with governance standards for the plurality of governable artifacts.

### CROSS-REFERENCE TO RELATED APPLICATIONS

The present application claims the benefit of priority from U.S. Provisional Application No's. 63/739,255 filed Dec. 27, 2024. U.S. Non-provisional application Ser. No. 18/941,215 filed Nov. 8, 2024, is incorporated herein by reference.

### TECHNICAL FIELD

The present disclosure relates generally to computer-implemented systems and methods for collecting, analyzing and distributing digital information. More specifically, and without limitation, this disclosure relates to computer-implemented systems and methods for collecting, analyzing, and distributing digital information for monitoring a digital environment and determining adherence to one or more governance standards. The systems and methods disclosed herein may be used in various applications, such as business systems, system environments, systems that benefit from monitoring, and systems comprising various sources of digital information and/or systems of record.

### BACKGROUND

In modern software development, organizations are increasingly challenged by the need to manage numerous application components across a highly complex and fast-evolving software development lifecycle. Software changes in the development lifecycle often encounter issues such as version conflicts or inconsistencies in code during implementation and deployment. For example, contradictions between different versions of code can arise, leading to challenges in maintaining alignment across teams and environments during the deployment process. Traditionally processes have been used to track code modifications and ensure adherence to compliance and governance standards prior to software deployment that present significant difficulties in accurately and efficiently verifying compliance for various reasons. These traditional processes may be limited in gathering data from various sources for efficient review, may have inconsistent record-keeping policies, may not be updated in real or near real time to ensure accurate records, and may not be properly enforced based on the governance requirements of different teams. In some cases, these traditional processes may depend on human attestation for verifying compliance with risk management and quality assurance requirements. Additionally, these traditional processes may be particularly susceptible to falsified attestations or errors or biases, posing significant risks to the integrity and security of the software being developed.

As organizations scale up and the number of application components increases, these challenges are further amplified. Relying on manual processes to manage hundreds or even thousands of components leads to inefficiencies, bottlenecks in the software development lifecycle, and an elevated risk of non-compliance with governance standards. Given the accelerated pace at which software is now developed and deployed, manual governance systems are no longer sufficient to meet the demands for precision, speed, and scalability. In digital application systems, it is therefore desirable to ensure that components within the systems adhere to governance standards and are compliant with design architecture, design principles, standards and decisions. In the context of this disclosure, governance standards may refer to standards developed by risk & security teams, change management teams (teams associated with minimizing disruptions and risks associated with changes to platform systems and services), platform teams, or other teams. The governance standards may be developed for governing aspects such as increased security for applications being built, providing stable and efficient technology solutions, and abiding by company specific development standards.

Existing systems and methods for monitoring adherence to governance standards, however, suffer from a number of drawbacks, including the inability to accurately monitor multiple governable artifacts and communicate the status of the governable artifacts to a user. Governable artifacts may include applications such as RESTful API's, Kafka streaming applications, angular front end apps, batch job apps and others. The governable artifacts may be used throughout the system for products and services offered by the provider. In addition, existing systems and methods are ineffective at sewing together multiple different vendor products that are not readily integrated. Existing solutions also are not capable of monitoring the status of compliance with governance standards for governable artifacts through a single portal. Consequently, existing systems struggle to provide real-time feedback for the status of multiple governable artifacts that are contained in multiple different vendor products.

Therefore, there is a need to overcome these and other drawbacks of existing solutions and for improved systems and methods for monitoring adherence to governance standards in a digital environment.

The abovementioned drawbacks are addressed by a “Governance dashboard” described herein by presenting the status of various controls, evaluated at build and deploy times. These controls include security scans (e.g., IAST, open source scan, etc.) that are beneficial in determining any risk of these applications failing to meet compliance standards while they are being built and deployed, presenting any known vulnerabilities, and ensuring the environment is stable and free of any exploits. The governance dashboard described herein may remove human attestation of risk compliance and quality assurance to remove subjective decision making and record keeping from the software development and deployment process. Implementing the governance dashboard may further streamline digital environment monitoring through implementation up continually updated controls to ensure loss of downtime due to faulty or non-compliant products.

### SUMMARY

In view of the foregoing, embodiments of the present disclosure provide computer-implemented systems and methods for monitoring adherence to governance standards. The description below provides exemplary aspects of some computer-implemented systems and methods for monitoring adherence to governance standards in accordance with some exemplary embodiments. Aspects may be combined with one or more suitable described aspects or other undescribed aspects. Aspects of one exemplary system or method may be combined with aspects of other exemplary systems, methods, or both.

The disclosed embodiments describe a computer implemented method for generating an interactive graphical user interface (GUI) for providing performance status information for one or more containers. A request may be sent to the one or more containers. A GUI may be a visual way to allow a user to interact with software using various graphical elements, including text, windows, icons, buttons, sliders, menus, links, audio, or visual elements. The one or more containers may contain governable artifacts configured to be monitored for adherence to governance standards. A response may be received from the one or more containers. The response may include a result of a governance compliance check indicating adherence to the governance standards. An indicator representative of the result of the governance compliance check may be displayed on the interactive GUI. The indicator may be based on the response from the containers. The interactive GUI may include a plurality of computer display boxes configured to indicate a status of adherence with governance standards for the plurality of governable artifacts.

According to some embodiments, a front-end interface may be configured to include the interactive GUI such that the front-end interface is configured to exchange digital information containing a status of the containers with the user via the interactive GUI.

According to some embodiments, the computer display boxes may be arranged in clusters, the clusters being configured to indicate a status of controls within the governable artifacts.

According to some embodiments, the interactive GUI may comprise indicators configured to indicate a summary of the status of compliance for more than one of the containers.

According to some embodiments the governable artifacts may include one or more of design principles, microservice standards, reference architectures, design patterns, style guides, style spreadsheets, or code frameworks.

According to some embodiments the indicator may be colored to indicate the result of the governance compliance check or a status of the governable artifacts.

According to some embodiments the indicator may be colored red to indicate failure to adhere to the governance standards.

According to some embodiments, the indicator may be colored green to indicate adherence to the governance standards.

According to some embodiments, the status of the governable artifacts may include one or more of active, inactive, positive result, negative result, pending, or error.

According to some embodiments, a selection may be received through the interactive GUI. A subset of the governance compliance checks may be displayed to show an outcome of the governance compliance checks in response to the selection.

According to some embodiments, a channel application may be provided that hosts a plurality of micro-applications, each micro-application of the plurality of micro-applications may be configured to perform one or more functions.

According to some embodiments, each micro-application of the plurality of micro-applications may be configured to include a front-end interface and an outer Application Programming Interface (API). The front-end interface may further be further configured to exchange digital information with a user device associated with a user.

According to some embodiments, the outer API may be configured to exchange digital information with at least one respective inner API.

According to some embodiments, each separate container may include a respective port configured to exchange digital information.

The disclosed embodiments describe a system for generating an interactive GUI for providing performance status information for one or more containers. The system may include a memory storing instructions. By at least one processor in electronic communication with the memory, a request may be sent to one or more containers. The one or more containers may contain governable artifacts configured to be monitored for adherence to governance standards. By the at least on processor, a response from the one or more containers may be received. The response may include a result of a governance compliance check indicating adherence to the governance standards. By the at least one processor, an indicator representative of the result of the governance compliance check may be displayed on the interactive GUI. Based on the response from the containers, the interactive GUI may include a plurality of computer display boxes configured to indicate a status of adherence with governance standards for the plurality of governable artifacts.

According to some embodiments. a front-end interface may be configured to include the interactive graphical user interface such that the front-end interface exchanges digital information containing a status of the containers with the user via the interactive graphical user interface.

According to some embodiments, computer display boxes may be arranged in clusters. The clusters may be configured to indicate a status of controls within governable artifacts.

According to some embodiments, the interactive graphical user interface may comprise indicators configured to indicate a summary of the status of compliance for more than one of the containers.

According to some embodiments, governable artifacts may include one or more of design principles, microservice standards, reference architectures, design patterns, style guides, style spreadsheets, or code frameworks.

According to some embodiments, the indicators may be colored to indicate the result of the governance compliance check or a status of the governable artifacts.

The foregoing general description and the following detailed description are exemplary and explanatory only and are not restrictive of the claims.

### BRIEF DESCRIPTION OF THE DRAWINGS

The accompanying drawings, which are incorporated in and constitute a part of this disclosure, illustrate various disclosed embodiments. In the drawings:

FIG. 1A is a narrative illustration portraying the challenges associated with efficiency within a governance dashboard.

FIG. 1B is a narrative illustration portraying a user using a governance dashboard in accordance with some embodiments of the present disclosure.

FIG. 2 is a flowchart of an exemplary process for monitoring a system environment, consistent with some embodiments of the present disclosure.

FIG. 3 is an exemplary GUI display, consistent with some embodiments of the present disclosure.

FIG. 4 is an exemplary GUI display, consistent with some embodiments of the present disclosure.

FIG. 5 depicts an example computing device, in accordance with the disclosed embodiments.

FIG. 6 depicts an exemplary information exchange system, consistent with some embodiments of the present disclosure.

FIG. 7 illustrates an exemplary process for configuring governance requirements, consistent with some embodiments of the present disclosure.

FIG. 8 is a flowchart of a further exemplary process, for configuring governance requirements, consistent with some embodiments of the present disclosure.

FIG. 9 depicts a chart illustrating a relationship between events and attestations, in accordance with some embodiments of the present disclosure.

### DETAILED DESCRIPTION

The following detailed description refers to the accompanying drawings. Wherever possible, the same reference numbers are used in the drawings and the following description to refer to the same or similar parts. Unless otherwise defined, technical and/or scientific terms have the meaning commonly understood by one of ordinary skill in the art. The disclosed embodiments are described in sufficient detail to enable those skilled in the art to practice the disclosed embodiments. While several illustrative embodiments are described herein, modifications, adaptations, and other implementations are possible. For example, substitutions, additions, or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended claims.

Embodiments disclosed herein describe computer implemented systems or methods for generating an interactive graphical user interface for providing performance status information for one or more containers. The systems or methods may comprise sending a request to the one or more containers, the one or more containers containing governable artifacts configured to be monitored for adherence to governance standards, receiving a response from the one or more containers, the response may include a result of a governance compliance check indicating adherence to the governance standards. The systems or methods may display, on the interactive graphical user interface, an indicator representative of the result of the governance compliance check, based on the response from the containers, the interactive graphical interface may include a plurality of computer display boxes configured to indicate a status of adherence with governance standards for the plurality of governable artifacts.

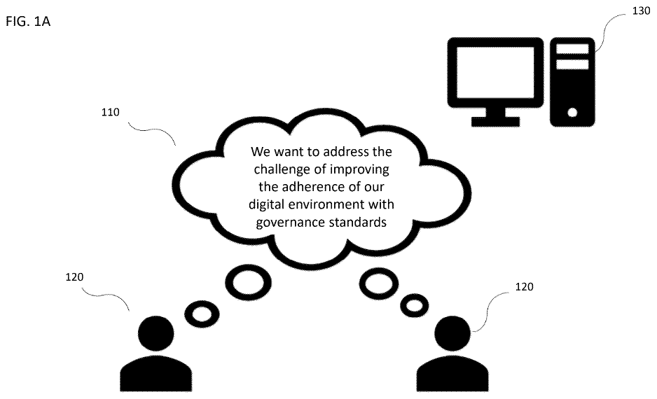

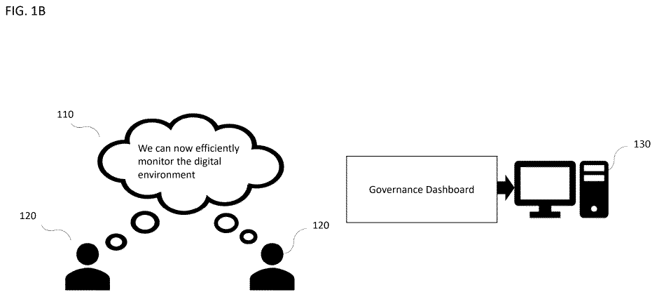

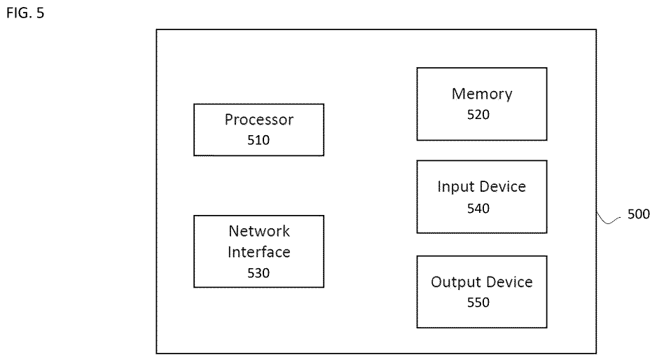

FIG. 1A is a narrative illustration portraying the challenges 110 associated with the efficiency of a governance dashboard within a computer system 130. A computer system may refer to a system including both hardware, as defined in FIG. 5, and software, as described herein. FIG. 1A depicts a team of developers 120 collaboratively addressing the challenge 110 of improving efficiency of a governance dashboard. Developers may include software developers, programmers or users.

FIG. 1B is a narrative showing a team of developers 120 having addressed the challenge of improving efficiency of a digital environment using the governance dashboard described herein.

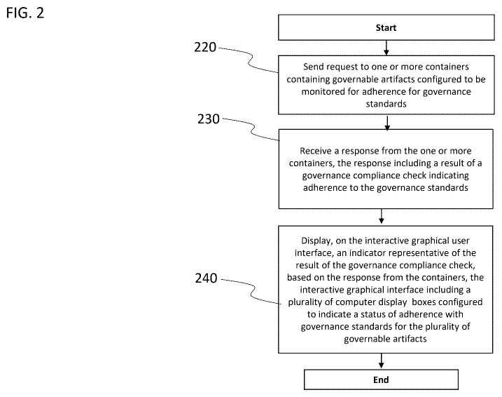

The challenges as described herein are addressed by the development of the governance dashboard shown in FIG. 2.

FIG. 2 shows an exemplary process of monitoring a system environment with a governance dashboard in accordance with disclosed embodiments. The process starts with step 220. Step 220 includes sending a request to a container. The container may be required to meet governance standards in accordance with pre-determined policies. The request to the container may include instructions, which when implemented send the current adherence of the container. The adherence may demonstrate that the container is compatible with the required governance standards. In other embodiments, information may be sent that demonstrates how the container adheres to governance standards. The requirement of passing the current adherence of a container with required governance standards may be determined by what the control is configured to achieve. The configuration may be determined by a development team or may be automatically determined based on the pre-determined policies and the associated instructions. For example, the configuration may refer to security, audit, or other configuration. Governance standards may refer to standards developed by risk & security teams, change management teams, platform teams, or other teams. The governance standards may be developed for governing aspects such as increased security for applications being built, providing stable and efficient technology solutions, and abiding by company specific development standards. In digital application systems, building functionality in small, discrete pieces, commonly referred to as “micro-applications,” may be desirable. Micro-applications enable developers to work independently on separate features and functions, fostering flexibility and parallel development. Micro-applications themselves may be composed of various blocks or components, also known as containers. In some embodiments, the containers may be implemented as micro-applications. A micro-application may be configured to perform one or more discrete functions (e.g., by using logic embodied in computer-readable and/or executable code). The micro-application may include a front-end (i.e. a user interface, which may be a GUI) configured to receive input from a user (e.g., through buttons, or the like) and/or provide information to the user (e.g., through a display, or the like). For example, a micro-application may contain a front-end created using one or more web application platforms for receiving user input in the form of mouse clicks on a browser. The front-end may include the user interface of channel application.

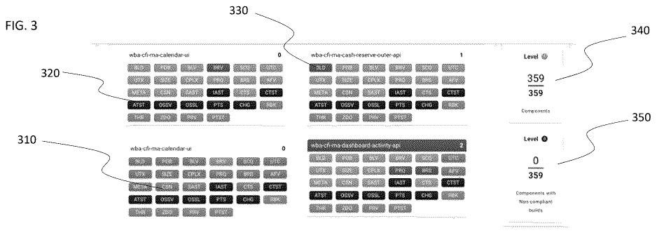

The system may receive the information sent from the container at step 230. In step 230, the system may receive a response from the one or more containers, the response including a result of a governance compliance check indicating adherence to the governance standards. The information received from the container may include the response generated by the API indicating the result of the governance compliance check, further detail of the results is shown in FIG. 3.

Once the governance compliance check of step 230 is complete, the result of the governance compliance check may be displayed by the GUI at step 240. The governance dashboard may display, on the interactive GUI, an indicator representative of the result of the governance compliance check, based on the response from the containers, the interactive GUI including a plurality of computer display boxes (as illustrated in FIG. 3) configured to indicate a status of adherence with governance standards for the plurality of governable artifacts. The governable artifacts may include one or more of design principles, microservice standards, reference architectures, design patterns, style guides, style spreadsheets, or code frameworks. Design principles may refer to guidelines that assist developers to create efficient, maintainable and robust systems. Design patterns may refer to reusable solutions for re-occurring problems in the design of the software. Microservice standards may refer to standards that are developed to build applications as a collection of small, independent services. Reference architecture may refer to one or more documents that provide recommended structures and templates for designing and implementing software systems. Style guides may refer to sets of rules and conventions that dictate the writing, formatting and structure of code. Style spreadsheets may refer to sheets containing the languages and styles used to render elements of the software. Code frameworks may refer to pre-build structures used for streamlining software development.

Once the check is complete, an error may be diagnosed by the developers. The system may run a script to address the error automatically. Alternatively, the error may need to be addressed by the developers by updating the policies governing the containers. The computer display boxes may be arranged in clusters, the clusters being configured to indicate a status of controls within the governable artifacts.

In the context of this disclosure “compliance” or “adherence” may refer to compliance or adherence with governable artifacts such as design principles, microservice standards, reference architectures, design patterns, style guides, style spreadsheets, or code frameworks, internal or external pre-defined policies and standards, such as quality standards, safety standards, or other known compliance requirements. Compliance checks may be performed at various levels of the development process through a CI/CD Devops pipeline. These checks may be performed automatically during each pipeline job, generating attestations for each required governance standard and sent to the governance dashboard platform for storing and displaying to the user. The governance dashboard platform may store attestations and metadata in a database. For example, selecting one of the display boxes 310, 320, 330 within the dashboard may present the user with formatted data of the metadata stored within the database. The formatted data presented to the user may be JSON formatted data or another form of formatted data.

CI/CD herein refers to continuous development (CD) or continuous integration (CI) pipeline related to the deployment of code. A continuous integration pipeline may refer to an automated process to help develop, integrate, or test code changes continuously. A code development pipeline may also capture pull requests, SonarQube™ scans, Sysdig™ scans, and Checkmarx™ scans or other types of scans related to pull requests. Pull requests may refer to a mechanism for a developer to try to incorporate code into a software environment. For example, a developer may initiate a pull request to propose changes to software code. SonarQube™ scans may analyze code quality by detecting bugs, vulnerabilities, etc. Sysdig™ scans may be scans that assess software or cloud security by providing visibility into vulnerabilities, compliance, or performance metrics. Checkmarx™ scans may be a security testing solution that analyzes source code for vulnerabilities. A code development pipeline may incorporate a DevOps toolchain used in the delivery, development, and management of software applications. The DevOps toolchain may be the tools used for a developer to plan, update, add, or manage code. In some embodiments, the system record may store metadata associated with the event. The system record with metadata may be transferred to code development pipeline, which may capture event metadata to create control attestations. Metadata may be structured information that describes, explains, or otherwise provides context for data, making the data easier to locate, manage, and use. Metadata may serve as a component in data management and organization, facilitating the retrieval and use of information across various systems. The system records may be used to provide an auditable trail of metadata for the events preceding the deployment of a component of a software application. An auditable trail may be a systematic, chronological record of activities, events, or transactions that provides evidence of the sequence and details of actions taken within a system. In some embodiments, the disclosed embodiments may utilize cloud-native technologies, such as Open Policy Agent, Go, gRPC, Knative, kafka, kubernetes, and cloud-native technologies suitable for developing and deploying software code. Software code may be a set of instructions written in any programming language that is executed by a computer or other computing device to perform specific tasks or functions. Programming languages may include Python, Java, C++, C, etc. Cloud-native technologies may refer to a collection of tools, practices, or architectures that are designed to build and run scalable applications such as cloud networks. The disclosed embodiments may further support custom-developed software applications across a variety of businesses. These applications include, but are not limited to, Ephemeral Jenkins™ and Azure DevOps™.

Pre-defined policies may be a set of rules or guidelines that are defined in a machine-readable format and used to govern the behavior of applications or infrastructure. These policies may be created in advance to enforce security, compliance, operational, or organizational standards automatically within a software development or deployment pipeline. The policies may be created by teams based on the requirements and objectives of a particular organization. The policies may be identified and defined by teams after reviewing and consulting legal experts and leadership to ensure alignment with legal and regulatory requirements. In some embodiments, at least one policy of the pre-defined policies may be a user-defined policy. The pre-defined policy may be set or required by a working group, such as a build or deployment team, or a development or security team. Upon a user selection of an interactive button on a GUI, a window of the GUI may be displayed and a user modification may be received via the window. Such policies may allow organizations or users to customize governance, compliance, or operational rules according to their specific needs. Unlike standard, built-in policies, these user-defined policies may be created to address unique requirements, such as enforcing custom security protocols, managing resource usage, or ensuring compliance with niche industry regulations. By integrating these custom policies into an automated governance system, organizations may ensure that their specific rules are automatically enforced, providing flexibility while maintaining consistency and control throughout the software development or operational lifecycle.

FIG. 3 shows an embodiment of a GUI. The front-end interface of a micro-application may refer to the user-facing part of the software system. The front-end interface may be designed to interact directly with users, presenting information and receiving inputs. For example, in some embodiments the front-end interface may include a GUI. FIG. 3 shows an example GUI, and the front-end interface may be configured to exchange the digital information with the user's device via the GUI. In some other embodiments exchange of digital information may be performed through other forms of user interaction (e.g., command-line interface, voice-user interface, biometric interface, Natural language Processing (NLP), or multi-modal interfaces). One of the purposes of the front-end interface may be to provide a user-friendly experience, allowing users to interact with and manipulate digital information in a way that is intuitive and accessible.

Micro-applications may each be associated with one or more GUIs configured to enable and allow a user to view information or to interact with the system. As shown in FIG. 3, the user may interact with the system through the GUI, which may include a plurality of interactive buttons representing the respective outcome of the governance check. The outcome may be indicative of whether governance a check is satisfied, not satisfied, not required, or unavailable. The GUI may include a plurality of interactive buttons representing the respective outcome. For example, in FIG. 3, each of the display boxes (310, 320, 330) show whether governance check is satisfied or not for a particular container or collection of containers being represented by the display boxes (310, 320, 330).

In some embodiments, the GUI illustrated in FIG. 3 may display an indicator representative of the result of a governance compliance check for one or more containers. The indicator may include a plurality of computer display boxes 310, 320, 330 configured to indicate adherence to governance standards. The result of the governance compliance checks may determine the color of the computer display box in the GUI. The indicator may be colored to indicate the result of the governance compliance check or a status of the governable artifacts. For example, failure to adhere to the governance standard may result in a red 330 or orange 310 display box. Adhering to a governance standard may result in a green display box 320. An orange label may indicate that the associated container contains an error, and that the container is still functional. A red label may indicate that the associate container contains an error and is non-functioning. Other colors, symbols or indicators may be used to indicate other status updates. For example, the status of the governable artifacts may include one or more of active, inactive, positive result, negative result, pending or error. A positive result may indicate adherence to governance standards. A negative result may indicate non-adherence to governance standards.

Alternatively, a negative result may not indicate non-adherence to governance standards. The negative result may indicate that a subset of the container is at risk of non-adherence to governance standards, for example, if a threshold for failure has not been exceeded, but the threshold is close to being exceeded, a warning may be displayed by an indicator 340, indicating that a threshold is close to being exceeded. For example, the indicator may be displayed if an error has not yet occurred but the monitored container is at risk of non-adherence to the required governance standard. The GUI of FIG. 3 may include an indicator 340 that indicates the total number of containers that adhere to one or more pre-determined governance standards within the system. The GUI of FIG. 3 may further include an indicator 350 that indicates the total number of containers that do not adhere to one or more pre-determined governance standards within the system. A combination of individual computer display boxes 310, 320, 330 and indicators 340, 350 improves a user's ability to monitor a banking environment by providing a multi-level summary of compliant containers relaying the required information to the user, which results in a system in which a user may not always need to review the status of each individual container. If a user does not need to review each individual container, and views the top-level summary of compliant or non-compliant containers, efficiency of container monitoring is improved. Indicators 340, and 350 provide the top-level summary of compliant and non-compliant containers, which may trigger a user to consult the individual computer display boxes and identify the non-compliant container, thus providing more efficient governance monitoring through a single portal, because a user does not always need to open individual container compliance summaries to determine compliance of a multi-container system. For example, a container that does not adhere to one or more pre-defined governance standards, as identified by the compliance check, will be labeled as non-compliant in the GUI. The non-compliant container may be displayed to the user using an indicator as described above with reference to the GUI of FIG. 3. In some embodiments, errors may be triggered in the containers by a threshold being exceeded within the system environment. Errors may be triggered by events generated within the system environment. For example, the errors may be generated by the micro-applications and stored in the respective log files. The log files may be stored in log books, which contain multiple log files containing errors generated by the micro-applications. A monitoring system may be configured to monitor the log books and identify the error codes within the log books. Alternatively, in some embodiments, the error codes may be sent directly to the governance dashboard.

In some embodiments, the user may receive a selection through the interactive GUI, and display a subset of the governance compliance checks to show an outcome of the governance compliance checks in response to the selection. In some embodiments, a user may interact with the GUI of FIG. 3 to select and display a subset of the governance compliance checks to show an outcome of the governance compliance checks. The subset may be shown by a user selecting one or more of the display boxes (310, 320, 330), to expand the display box on the same dashboard, or a separate dashboard showing the subset for the selected display box. and present the governance compliance check subset. A subset may be determined in the development stage of the governance process, by a development team. The subset may include a breakdown of the compliance checks and results carried out on the container represented by the display boxes 310, 320, 330. The governance controls may be created by a developer. The developer may design, implement, test, and deploy the governance controls out to a deploy environment via an automated CI/CD pipeline. The governance controls may be implemented during software deployments that allow for upgrades and changes to be made and deployed to the working environment. An event manager may be configured to implement the governance controls. The governance controls may further be implemented during a simulated working environment, to test the controls before deployment into an actual working environment.

For example, in FIG. 3 a user may select a computer display box displaying the status of one or more containers. Selecting the computer display box may expand a list of subsets showing the status of one or more of the individual components within the containers. The status may indicate adherence with governance standards. The status may be active, inactive, positive result, negative result, pending or error of the particular component. A user may select one or more of the sub-sets to display further detail of the status. For example, the detailed status may include further information of an error, such as specific error codes. Each governance compliance check generates an attestation based on the specific requirement of that control for it to pass. In an example of a governable event, an IAST (Interactive Security Testing) scan may require that any code libraries used in the digital environment cannot have any known high vulnerability records. High vulnerability records may include information, which includes known security flaws, and help organizations to identify and remediate application risks.

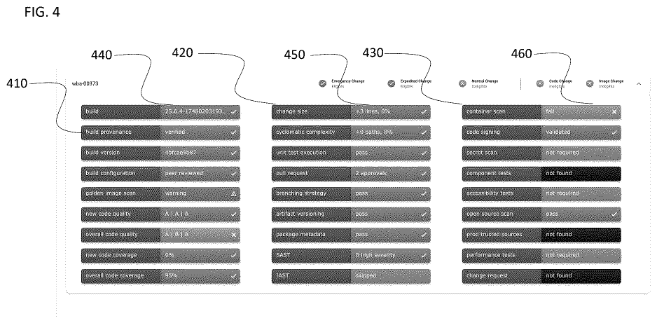

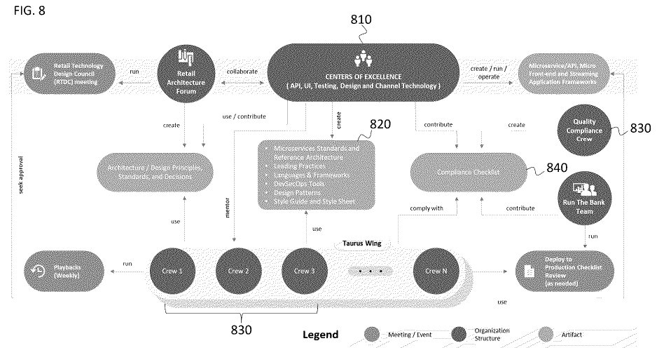

The attestations may be stored in a backend database and shown on the dashboard of FIG. 4 (440, 450, 460). FIG. 4 depicts an exemplary dashboard with a variety of additional details regarding each policy requirement corresponding to each container. The additional details include attestations, which provide a user with further information why a given policy is met, not required, not found, unavailable, or not met. By selecting different containers, a user may be enabled to review policy requirements associated with various versions of the container to understand changes resulted in varying compliance levels with the policy requirements. Example attestations are displayed with green, yellow, red, or other fill color. FIG. 8 provides further detail for attestation generation, and shows three columns of events and attestations. The example events 410, 420, and 430 are shown in the left of each column. The events of the database are displayed adjacent to a corresponding attestation 440, 460, 460. The attestation shows a detailed breakdown of the result of the event, which may include a pass, a fail, symbols, warnings or other results. A developer may configure the events and attestations through the backend database of FIG. 4.

FIG. 5 depicts an example of computing device 500, in accordance with disclosed embodiments. Various operations as described herein may be performed using computing device 500. Computing device 500 may include processor 510 and memory 520 storing instructions that, when executed by the at least one processor, may cause the at least one processor to perform one or more operations as described herein. Processor 510 may include, for example, central processing units (CPUs), graphics processing units (GPUs), digital signal processors (DSPs), field programmable gate arrays (FPGAs), integrated circuits, microcontrollers, microchips, microprocessors, or other units suitable for executing instructions or performing logic operations. Processor 510 may include a single-core or multiple-core processor (e.g., dual-core, quad-core, or with any desired number of cores). Processor 510 may provide the ability to execute, run, control, manage, or store multiple processes, applications, or programs. Memory 520 may include a non-transitory computer-readable medium that may store instructions. Memory 520 may include, for example, volatile memory, non-volatile memory, flash drives, caches, registers, hard drives, disks, an optical data storage medium, a physical medium with patterns, random access memory (RAM), read-only memory (ROM), programmable read-only memory (PROM), erasable programmable read-only memory (EPROM), compact disc read-only memory (CD-ROM), digital versatile discs (DVDs), non-volatile random-access memory (NVRAM), or networked versions thereof.

Computing device 500 may further include at least one network interface 530 (e.g., a network card, a modem, and/or any other device that may be configured to provide data communication via a network), one or more input devices 540 (e.g., a keyboard, a mouse, a touch screen, a joystick, a touch pad, one or more buttons, a microphone, a sensor, and/or any other device configured to detect and/or receive input), and/or one or more output devices 550 (e.g., a display (e.g., a light-emitting diode (LED) display, a liquid-crystal display (LCD), an organic light-emitting diode (OLED) display, or a dot-matrix display), a screen, a touch screen, a headphone, a speaker, a light indicator, a light source, a device configured to provide tactile cues, a vibrator, and/or any other device configured to provide output).

In some embodiments, a front end interface may be configured to include the interactive graphical user interface such that the front-end interface is configured to exchange digital information containing a status of the containers with the user via the interactive graphical user interface. In some embodiments, each separate container (Front-end container, Outer API container, Inner API container) may include a respective port for exchanging digital information. In a containerized environment, containers often need to communicate with each other or with external systems. In this context, ports may refer to communication endpoints that allow containers to exchange digital information. Each container may be configured to expose one or more ports to facilitate communication with other containers, services, or external clients. By exposing ports, containers may listen for incoming network requests and send out responses or requests. Ports may be labeled using numbers, for example, a container may expose a port with a given number label for RESTful API requests.

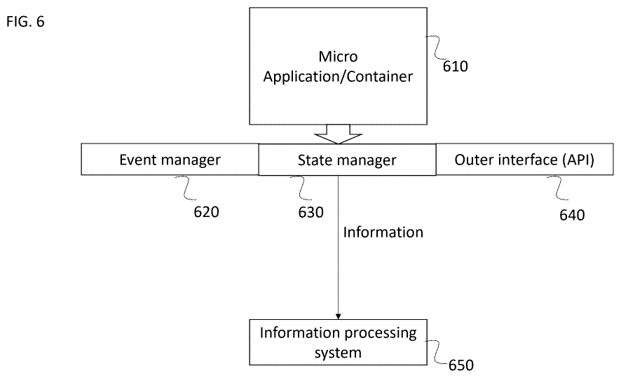

FIG. 6 shows information exchange between a micro application (610) and an information processing system (630). The micro-application may include an outer interface (640) (e.g., an application programming interface (API), or the like) for receiving and sending information from and to an information processing system (650) using the connector (e.g., using an external application programming interface (API), or the like). An API may be any software used to interface or exchange information between two or more computer programs or devices. An information processing system may refer to a system configured to receive and process the information generated by one or more micro-applications. For example, a micro-application (610) may contain an outer interface (640) created using a cascading style sheet (CSS) framework, such as BOOTSTRAP, and the processing system may contain a corresponding external application interface for communicating with the outer interface. As shown in FIG. 6, the micro-application (610) may further include an event manager (620) configured to send and receive event information to and from the information processing system (650), as well as a state manager (630), configured to send and receive state information to and from the information processing system (650). An event manager may be a component, which handles and responds to events which occur within the system. A state manager may be a component configured to maintain the state of a micro-application across various components within the digital environment. For example, in a financial setting, the event manager may publish information regarding business events such as financial transactions by a customer to the event backbone through a system of recording using a first external application programming interface (API), and the state manager may receive information regarding the customer's present account balance from the event backbone using a second external application programming interface (API). In this manner, the read-and-write functionality between micro-applications and the processing system may be scaled differently.

In accordance with FIG. 6, some embodiments of the present disclosure may involve a computer-implemented system for collecting and distributing digital information. The computer-implemented system may include a channel application that hosts a plurality of micro-applications each configured to perform one or more functions. In the context of this disclosure, a channel application may also be referred to as a “driver application” and may refer to a software platform designed to host and manage multiple micro-applications. A channel application may serve as a centralized interface through which these micro-applications can operate, interact, and be accessed by users. The channel application may provide the necessary infrastructure, resources, and integration points to ensure that each micro-application functions correctly and can communicate with other micro-applications or external systems. A channel application may also handle user authentication, data routing, and overall system orchestration to streamline the deployment, monitoring, and management of the micro-applications it hosts. Conversely, a micro-application may refer to a small, independent software component designed to perform specific functions within a larger system. Each micro-application may be focused on a particular task/business function or set of tasks/business functions, which may make it modular and easily manageable. Micro-applications may operate autonomously but may interact with other micro-applications through well-defined interfaces, such as APIs. This modular approach may allow for greater flexibility, scalability, and ease of maintenance, as each micro-application can be developed, deployed, updated, and scaled independently of others.

In some embodiments, channel applications may be embodied as software stored in a non-transitory computer-readable medium that when executed by a processor causes operations, functions, and results described herein to be realized. A user may use a channel application on a computer, mobile device (e.g., cellular phone, smartphone, tablet, personal digital assistant, smart appliance, kiosk, etc.), or other electronic devices to review or interact with information, for example, with banking information relating to the user's bank account. The channel application may host a plurality of micro-applications, each micro-application of the plurality of micro-applications being configured in response to the selection.

In some embodiments, each micro-application of the plurality of micro-applications may include a front-end interface and an outer Application Programming Interface (API). The front-end interface may be configured to exchange digital information with a user, and the outer API may be configured to exchange digital information with at least one respective inner API.

Outer APIs may refer to interfaces utilized for channel applications/micro-applications or exposed to third parties. Outer APIs may serve as the bridge between the front-end and the back-end systems. Outer APIs may orchestrate calls to Inner APIs, filter and transform data to fit the channel experience, and prepare data for consumption by the front end. Outer APIs may be tightly coupled with the front and be unique to each user experience. Outer APIs may be documented in a developer platform for developing digital experience applications. Such a platform may provide developers with a common user interface framework enabling the development of consistent and standard digital experience applications. In addition, a developer platform may provide developers with the toolkit, components, and libraries to ensure proper automated testing, debug and build patterns, and ensure that applications are built to architecturally approved standards.

Inner APIs may refer to specialized interfaces designed specifically for backend systems within a micro-application architecture. These APIs may serve as a layer of abstraction that facilitates communication and interaction between the micro-application's front-end and its backend systems. By using Inner APIs, micro-applications may achieve loose coupling, meaning they are less dependent on the specific implementation details of the backend systems they interact with. In some embodiments, Inner APIs may adhere to a specific model. For instance, in the context of a digital banking platform, Inner APIs might follow the BIAN (Banking Industry Architecture Network) API Model and utilize the BIAN Object Model (BOM). The BIAN API Model provides standardized guidelines and protocols for defining APIs in the banking domain, ensuring consistency, interoperability, and scalability across different banking services and applications. Meanwhile, the BIAN Object Model (BOM) defines a standardized approach to representing banking domain objects and their relationships, enhancing data consistency and compatibility within the micro-application ecosystem.

In some embodiments, the at least one inner API may include a write API and a read API. In other words, inner APIs may be categorized into read APIs and write APIs based on a Command Query Responsibility Segregation (CQRS) pattern, i.e., a design approach in software engineering that advocates for the separation of concerns between handling write (command) and read (query) operations on data within a system. In some embodiments, the write API may be configured to receive digital information from a micro-application and send the received digital information to a system of record (SOR). A System of Record (SOR) may refer to a centralized data storage system or database that is authoritative and holds the official version of a particular set of data within an organization. An SOR may serve as the primary source of truth for specific types of information or transactions. Once the write API has received digital information from a micro-application, it may forward or send this digital information to the SOR. This process may ensure that the data originating from the micro-application is stored in the authoritative and centralized repository (the SOR), where it becomes the official and trusted record. This integration between the micro-application and the SOR may enable consistent data management, enhance data integrity, and support efficient data access and retrieval across the organization's ecosystem. In some embodiments, the read API may be configured to send digital information to a micro-application and retrieve digital information from a system of reference via a Data Streaming Platform (DSP). A DSP refers to a software infrastructure that enables the continuous ingestion, processing, and analysis of real-time data streams. A DSP may provide the necessary tools and frameworks to manage and manipulate data streams from various sources in a scalable and efficient manner. The read API may send digital information to a micro-application, enabling the micro-application to access and consume real-time data streams processed by the DSP. Additionally, the read API may retrieve digital information from a system of reference also referred to as a “book of reference” via the DSP. In the present context, a system of reference or “book of reference” may refer to a specific data source or repository managed by the DSP, where historical or reference data is stored and made available for querying and analysis.

In some embodiments, the at least one inner API may include an external API configured to exchange digital information with an external system. External APIs are designed to be accessible to systems and organizations outside of the primary computer-implemented system. For instance, in the context of a digital banking platform, external APIs might include Open Banking APIs (e.g., QuickBooks, Mint, Financial Data Exchange—FDX, etc.). These APIs may provide well-defined endpoints and may use the REST (Representational State Transfer) architecture over the HTTP (Hypertext Transfer Protocol). External APIs are intended to cater to third-party consumers, such as other financial institutions, fintech companies, and service providers, enabling them to interact with the banking platform's services and data securely and efficiently.

In some embodiments, a write inner API may be configured to receive event information from one or more micro-applications. In some embodiments, the write inner API may send the received event information to one or more systems of record (SOR). SOR may process the event information and update the information to the system of reference. In some embodiments, the write inner API may be created using the Micron framework (an open-source framework used for building high-performance, lightweight microservices and serverless applications in Java). In some embodiments, a read inner API may send information to one or more micro-applications. A read inner API may be created by exposing data in a data store. In some embodiments, the read inner API may use an internal or external cache to speed up API responses. In some embodiments, the read inner API may be created using the Micron framework. In some embodiments, the read inner API and the system of reference may be deployed as a central data location.

Each micro-application may be configured to perform one or more functions or a portion of the functionality of a given channel application. In the context of the present disclosure, a “vertical slice” may refer to a portion of functionality in a software system that spans all layers of the application stack, from the GUI down to the data storage layer. Accordingly, consistent with the disclosed embodiments, a vertical slice may include a user interface tightly coupled to a front end, an outer API, and at least one inner API, such as a write API and/or a read API, which are coupled respectively to a system of record or a system of reference. In order to be available for use, a vertical slice needs to be deployed.

In some embodiments, the front-end interface, the outer API, and the at least one respective inner API of each micro-application may be packaged in separate containers. Containers are technologies that enable the packaging and isolation (also referred to as containerization) of applications or micro-applications along with their complete runtime environment, encompassing all the necessary files for execution. The use of containers may facilitate the movement of applications across various environments, such as development, testing, and production while preserving their full functionality. Containers may also enhance IT security. By integrating security measures into the container pipeline and safeguarding the underlying infrastructure, containers may maintain reliability, scalability, and trustworthiness. Moreover, containers may facilitate easy migration of applications between public, private, and hybrid cloud environments, as well as on-premises data centers, ensuring consistent behavior and functionality. The deployment of containerized applications may help mitigate conflicts between development and operations teams by separating their respective responsibilities. Developers can focus on building applications while operations teams can concentrate on managing the infrastructure. Furthermore, in some embodiments, the front-end interface, the outer API, and the at least one inner API may be containerized using a platform for building and running containers, such as DOCKER. In some other embodiments, other open-source containerization technologies such as PODMAN, SKOPEO, BUILDAH, CRI-O, or KUBERNETES may be used. The use of open-source containerization technologies may guarantee access to the latest advances as soon as they become available.

This additional level of granularity, as shown by the GUI of FIG. 3 and supporting FIGS. 5 and 6, may further enhance the development process by allowing developers to focus on specific parts of the application. For instance, some blocks (front-end blocks) may be dedicated to the user interface and user experience aspects of the micro-application, other blocks (back-end blocks) may handle the server-side logic, data processing, and business rules, and additional blocks (communication blocks) may manage communication with central data repositories or external services. Micro-application blocks may refer to lightweight, standalone, and executable packages that may include everything needed to run a piece of software. For example, each block may encapsulate code, runtime, system tools, libraries, and settings. These blocks may be self-contained units that can function independently. They may also be combined with other blocks to build more complex systems, such as a full-fledged micro-application.

Some micro-application blocks may be unique to a particular micro-application, tailored to its specific needs and functions. Conversely, other blocks may be common or shared across multiple micro-applications, promoting code reuse and consistency throughout the system, thereby reducing redundancy and facilitating maintenance. For example, a digital banking platform composed of various micro-applications might include User Account Management, Transaction Processing, and Customer Support micro-applications. The User Account Management micro-application may have front-end blocks for the user dashboard, back-end blocks for managing user data, and communication blocks for interacting with a central user database. The Transaction Processing micro-application might include blocks for transaction entry forms, backend processing logic, and communication blocks for real-time financial data synchronization. The Customer Support micro-application may consist of blocks for a support ticket interface, backend blocks for ticket management, and communication blocks to access user and transaction data for support purposes. In this scenario, certain blocks, such as authentication and user profile management, might be shared across all three micro-applications, ensuring a consistent user experience and simplifying the overall system architecture.

Once the different micro-application blocks (containers) are created, an additional layer of abstraction may be added to manage and deploy them, making the micro-application blocks available for use (i.e., moving a block from a development environment, where it is built and tested by developers, to a production environment where it is used by users). This layer, which may be known as a “pod,” may represent the smallest unit of deployment. Some deployments involve small, nimble pods that include a single container. Small pods may lead to efficiency gains associated with rapid pod deployment and teardown, particularly evident in smaller pod configurations that consume fewer resources and start up more quickly. However, different challenges are associated with this single-container-per-pod approach, such as ensuring reliable inter-service communication among micro-application blocks, complicated by issues like latency, network failures, and serialization overhead. Managing deployments individually for each micro-application block may increase operational complexity and risk version mismatches. Moreover, varying resource requirements across blocks may necessitate careful allocation to avoid inefficiencies and potential contention. Maintaining data consistency and synchronization across separately deployed components may pose further challenges, exacerbated by the complex aggregation of monitoring data and logs from disparate sources. Additionally, securing communication and managing network policies between different components may add another layer of complexity to deployment and maintenance processes.

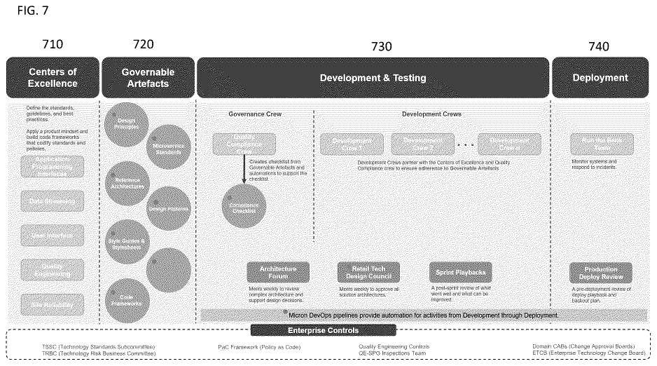

FIG. 7 illustrates a breakdown of the governance process in the build up to deployment of governance standards. 710 shows a collection of centers of excellence. The centers of excellence define standards, guidelines and best practices, which are to be followed in system builds. Centers of excellence may include API's, data streaming, user interface, quality engineering and site reliability. 720 shows governable artifacts, as discussed previously. The governable artifacts 720 are those which the containers being monitored must adhere to. 730 illustrates the development and testing phase. At development and testing phase 730, a governance crew may create a compliance checklist. A governance crew may be a crew responsible for system governance, such as a quality compliance crew. The compliance checklist may be a checklist indicating which artifacts are compliant. Development and testing phase 730 further includes a development crew. The development crew partner with the centers of excellence and quality compliance crews to ensure adherence to governable artifacts within the system. The deployment stage of the governance process is shown at 740. At 740, the governance process may be deployed to run in a digital environment.

FIG. 8 illustrates a process flow of the development of governance standards and compliance shown as described herein, in relation to FIG. 7. The process flow of FIG. 8 shows the interaction between crews 830 with governable artifacts 820 and centers of excellence 810. In FIG. 8, the compliance checklist 840 is shown, which is created by the quality compliance crew 830. As shown in FIG. 8, the centers of excellence contribute to the compliance checklist. Other crews, such as the development crew, may use the governable artifacts 820, along with the centers of excellence to ensure that the governable artifacts 820 comply with the compliance requirements in the compliance checklist 840.

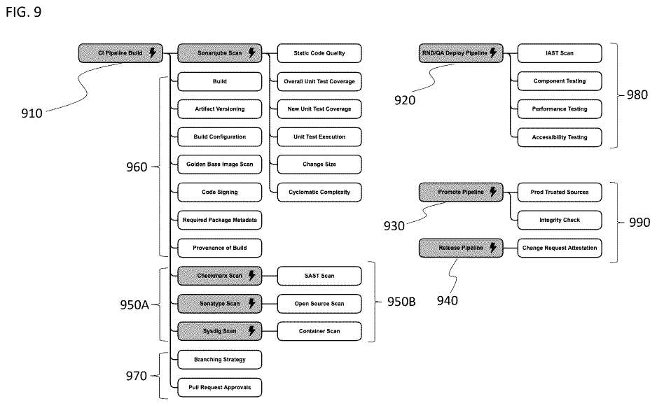

FIG. 9 illustrates the generation of attestations through four events. Each of the four events may produce more than one attestation. An event may be an event occurring in the system, for example a container scan. Attestations may be created based on specific events, the result of an attestation from an event may be displayed on the GUI. In FIG. 9, dark gray boxes 910, 920, 930, 940, 950A depict events, while white boxes depict attestations 950B, 960, 970, 980, 990. For example, CI Pipeline Build 910 is an example of an event that produces 17 attestations from a single event. The same event may also trigger four subsequent events leading to additional attestations (adding up to 17 total attestations, shown in white boxes). The events 950A may include scans, such as checkmakers scan, sonatype scans or sysdig scans. Sonatype scans may analyze code quality by detecting bugs, vulnerabilities, etc. Sysdig scans may be scans that assess software or cloud security by providing visibility into vulnerabilities, compliance, or performance metrics. Checkmakers scans may be a security testing solution that analyzes source code for vulnerabilities. The scan events 950A may result in the attestations 950B indicating the results of the scans. Other examples of events include a deploy pipeline 920, a promote pipeline 930 and a release pipeline 940. A deploy pipeline 920 may be a series of automated processes and stages that facilitate the deployment of software applications from development to production. A promote pipeline 930 may be a process that enables the movement of software artifacts through various environments, such as development, testing, and production. A release pipeline 940 may be a series of automated processes that prepare and deploy software artifacts to production environments.

Container technologies may simplify and accelerate application development and deployment, providing orchestration capabilities for streamlined processes. Containers may share the underlying operating system kernel and isolate application processes from the rest of the system, enabling seamless movement and utilization across various configurations in development, testing, and production. Due to their lightweight and portable nature, containers may offer faster development cycles and the ability to address evolving business requirements. While containers may run within virtual machines (VMs), they are not limited to virtual environments. Containers may provide a higher level of efficiency and flexibility compared to traditional virtualization technologies.

The present disclosure has been presented for purposes of illustration. It is not exhaustive and is not limited to precise forms or embodiments disclosed. Modifications and adaptations of the embodiments will be apparent from consideration of the specification and practice of the disclosed embodiments. For example, the described implementations include hardware, but systems and methods consistent with the present disclosure can be implemented with hardware and software. In addition, while certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations, and/or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps and/or inserting or deleting steps.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

Other embodiments will be apparent from consideration of the specification and practice of the embodiments disclosed herein. It is intended that the specification and examples be considered as examples only, with a true scope and spirit of the disclosed embodiments being indicated by the following claims.

According to some embodiments, the operations, techniques, and/or components described herein can be implemented by a device or system, which can include one or more special-purpose computing devices. The special-purpose computing devices can be hard-wired to perform the operations, techniques, and/or components described herein, or can include digital electronic devices such as one or more application-specific integrated circuits (ASICs) or field programmable gate arrays (FPGAs) that are persistently programmed to perform the operations, techniques and/or components described herein, or can include one or more hardware processors programmed to perform such features of the present disclosure pursuant to program instructions in firmware, memory, other storage, or a combination. Such special-purpose computing devices can also combine custom hard-wired logic, ASICs, or FPGAs with custom programming to accomplish the technique and other features of the present disclosure. The special-purpose computing devices can be desktop computer systems, portable computer systems, handheld devices, networking devices, or any other device that can incorporate hard-wired and/or program logic to implement the techniques and other features of the present disclosure.

The one or more special-purpose computing devices can be generally controlled and coordinated by operating system software, such as iOS, Android, Blackberry, Chrome OS, Windows XP, Windows Vista, Windows 7, Windows 8, Windows Server, Windows CE, Unix, Linux, SunOS, Solaris, VxWorks, or other compatible operating systems. In other embodiments, the computing device can be controlled by a proprietary operating system. Operating systems can control and schedule computer processes for execution, perform memory management, provide file system, networking, I/O services, and provide a user interface functionality, such as a GUI, among other things.

Furthermore, although aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM. Accordingly, the disclosed embodiments are not limited to the above-described examples but instead are defined by the appended claims in light of their full scope of equivalents.

Moreover, while illustrative embodiments have been described herein, the scope includes any and all embodiments having equivalent elements, modifications, omissions, combinations (e.g., of aspects across various embodiments), adaptations, or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods can be modified in any manner, including by reordering steps or inserting or deleting steps.

It is intended, therefore, that the specification and examples be considered as examples only, with a true scope and spirit being indicated by the following claims and their full scope of equivalents.

What is claimed is:

1. A computer implemented method for generating an interactive graphical user interface for providing performance status information for one or more containers, the method comprising:
sending a request to the one or more containers, the one or more containers containing governable artifacts configured to be monitored for adherence to governance standards;
receiving a response from the one or more containers, the response including a result of a governance compliance check indicating adherence to the governance standards; and
displaying, on the interactive graphical user interface, an indicator representative of the result of the governance compliance check, based on the response from the containers, the interactive graphical interface including a plurality of computer display boxes configured to indicate a status of adherence with governance standards for the plurality of governable artifacts.

2. The method of claim 1, further comprising configuring a front-end interface to include the interactive graphical user interface such that the front-end interface is configured to exchange digital information containing a status of the containers with the user via the interactive graphical user interface.

3. The method of claim 1 wherein the computer display boxes are arranged in clusters, the clusters being configured to indicate a status of controls within the governable artifacts.

4. The method of claim 1 wherein the interactive graphical user interface comprises indicators configured to indicate a summary of the status of compliance for more than one of the containers.

5. The method of claim 1 wherein the governable artifacts include one or more of design principles, microservice standards, reference architectures, design patterns, style guides, style spreadsheets, or code frameworks.

6. The method of claim 1 wherein the indicator is colored to indicate the result of the governance compliance check or a status of the governable artifacts.

7. The method of claim 6 wherein the indicator is colored red to indicate failure to adhere to the governance standards.

8. The method of claim 6 wherein the indicator is colored green to indicate adherence to the governance standards.

9. The method of claim 6 wherein the status of the governable artifacts includes one or more of active, inactive, positive result, negative result, pending, or error.

10. The method of claim 1 further comprising:
receiving a selection through the interactive graphical user interface; and
displaying a subset of the governance compliance checks to show an outcome of the governance compliance checks in response to the selection.

11. The method of claim 1 further comprising providing a channel application that hosts a plurality of micro-applications, each micro-application of the plurality of micro-applications being configured to perform one or more functions.

12. The method of claim 11 wherein each micro-application of the plurality of micro-applications is configured to include a front-end interface and an outer Application Programming Interface (API), and the front-end interface is further configured to exchange digital information with a user device associated with a user.

13. The method of claim 11 wherein the outer API is configured to exchange digital information with at least one respective inner API.

14. The method of claim 1 wherein each separate container includes a respective port configured to exchange digital information.

15. A system for generating an interactive graphical user interface for providing performance status information for one or more containers, the system comprising;
a memory storing instructions; and
at least one processor in electronic communication with the memory, the at least one processor configured to execute the instructions to:
send a request to one or more containers, the one or more containers containing governable artifacts configured to be monitored for adherence to governance standards;
receive a response from the one or more containers, the response including a result of a governance compliance check indicating adherence to the governance standards; and
display on the interactive graphical user interface. an indicator representative of the result of the governance compliance check, based on the response from the containers, the interactive graphical interface including a plurality of computer display boxes configured to indicate a status of adherence with governance standards for the plurality of governable artifacts.

16. The system of claim 15, further comprising a front-end interface configured to include the interactive graphical user interface such that the front-end interface exchanges digital information containing a status of the containers with the user via the interactive graphical user interface.

17. The system of claim 15, wherein the computer display boxes are arranged in clusters, the clusters being configured to indicate a status of controls within the governable artifacts.

18. The system of claim 15, wherein the interactive graphical user interface comprises indicators configured to indicate a summary of the status of compliance for more than one of the containers.

19. The system of claim 15, wherein the governable artifacts include one or more of design principles, microservice standards, reference architectures, design patterns, style guides, style spreadsheets, or code frameworks.

20. The system of claim 15, wherein the indicator is colored to indicate the result of the governance compliance check or a status of the governable artifacts.
